(19) United States
(12) Patent Application Publication
(10) Pub. No.: US 2014/0295121 A1
(43) Pub. Date: Oct. 2, 2014

(54) Label Media Having Multiple Adhesives and Adhesive Free Regions for use in an Electophotographic Printer

(71) Applicant: LEXMARK INTERNATIONAL, INC., Lexington, KY (US)

(72) Inventors: Eric Len Ogden, Berea, KY (US); Gregory Paul Pulver, Lexington, KY (US); Phillip Daniel Jackson, Fort Scott, KS (US); Michael Thomas Whitehouse, Nicholasville, KY (US)

(73) Assignee: Lexmark International, Inc., Lexington, KY (US)

(21) Appl. No.: 13/851,384

(22) Filed: Mar. 27, 2013

(51) Int. Cl. G09F 3/10

(52) U.S. Cl. CPC G09F 3/10
USPC 428/41.9

(57) ABSTRACT

Label media having one of more labels with multiple adhesives having different adhesion characteristics and at least one adhesive free zone for use in an electrophotographic printer.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to removable adhesive-backed labels for use in an electrophotographic printers, and in particular, labels for use on retail shelving and for labeling of commercial laundry bags.

2. Description of the Related Art

In retail establishments or other applications, labels are used on retail shelving to attract customer attention and to inform them of product offerings and deals. These types of labels are sometimes referred to as “shelf talkers”. The labels have a low tackiness adhesive on portion of their reverse surface allowing the label to be removably attached to the shelving edge by stocking personnel. Currently flexible preprinted polyester, vinyl and other label facestock are used for the labels and are imaged using a non-laser printer such as a flexographic, offset, or thermal printer. However, because of temperature constraints, many of the label materials used in these processes are not suitable for use in an electrophotographic printers where heat and/or pressure is used to fuse toner to the labels. It would be advantageous to be able to create labels using electrophotographic printers that are commonly found in retail establishments and avoid the need for specialized printers or printing processes. Also the use of electrophotographic printers would allow for greater flexibility in the content of the labels.

As is well known, sheets containing any array N×M array of labels are available for electrophotographic printers. However, these typically as somewhat difficult to separate from their liner or carrier material because adhesive is applied to the entire reverse side of the label. Further it would be advantageous to have a sheet having an N×M array of labels where the labels are more easily peeled away from their liner or carrier sheet.

### SUMMARY

Disclosed is a media sheet for used in an electrophotographic printer that comprises a liner sheet, a label sheet having at least one label precut therein, and an adhesive for adhering the liner sheet and label sheet together. The at least one label may be an array of labels. The at least one label has a first portion having a first adhesive and a second portion having a second adhesive and a predetermined adhesive free zone extending inwardly from an edge of the at least one label within the second portion. The first adhesive may be coextensive with all of the edges of the first portion of the label and may be one of a low tack adhesive, a medium tack adhesive and a high tack adhesive while the second adhesive is a clean release adhesive.

The adhesive free zone may extend beyond the edge of the second portion of the at least of label into an abutting portion of the label sheet and may extend along the entire length of the edge of the second portion of the at least one label or about a corner of the second portion of the at least one label.

The label sheet may be made of one of polyester, vinyl, and paper and the liner sheet may be made of a silicone impregnated paper.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings.

FIG. 1A is an illustration of one embodiment of a removable label media of the present invention utilizing multiple adhesives and adhesive free zones.

FIG. 1B is a schematic illustration of the construction of the label media labels of FIG. 1A.

FIG. 2 is an illustration of a label media having an array of labels similar to those shown in FIG. 1.

FIGS. 3A-3D illustrate various shapes of labels for use on a label media.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Spatially relative terms such as “top”, “bottom”, “front”, “back”, “rear” and “side” “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise. One of ordinary skill in the art, and based on a reading of this detailed description, would recognize that, in at least one embodiment, the manner of making of the invention may be implemented in software. As such, it should be noted that a plurality of hardware and software-based devices, as well as a plurality of different structural components may be utilized to implement the invention. Furthermore, and as described in subsequent paragraphs, the specific configurations illustrated in the drawings are intended to exemplify embodiments of the present disclosure and that other alternative configurations are possible.

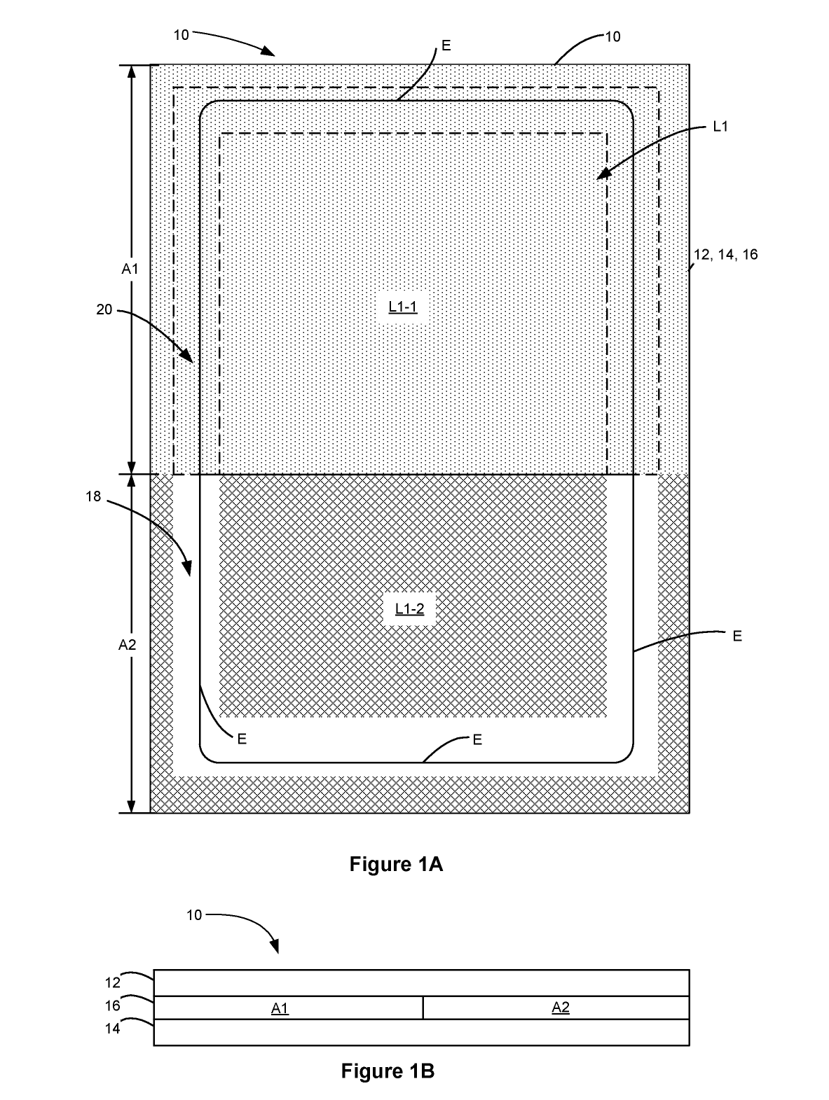

Shown in FIG. 1 is an example embodiment of a removably attachable label media 10. Label media 10 is comprised of a label sheet 12, a liner sheet 14 held together by an adhesive 16. Label sheet 12 may have one or more precut labels L1 provided therein with each label L1 have an perimeter edge E along which it is peeled or removed from the liner sheet 16. Prior to assembling the label media, the label sheet is scored with an outline of one or more labels L1 that is to be provided on the label sheet 12. Next multiple adhesives, generally indicated by the letter A, are applied to one of the label sheet 12 or the liner sheet 14. The adhesives A may be sprayed or printed onto the label sheet 12. The liner sheet 14 and label sheet 12 are then pressed together to form the label media 10. The label media 10 is sized to fit within a media input drawer of an electrophotographic printer and may be Letter size, A4, Ledger size etc as is commonly known to one of ordinary skill in the art.

For purposes of illustration only, the following will described the adhesives A being applied to the reverse side of the label sheet 12. As illustrated two adhesives, A1 indicated by the stippling and A2 indicated by the cross hatch, are applied to respective predetermined first and second portions L1-1, L1-2 of the label L. The overall area and shape of each portion L1-1, L1-2 is a matter of design choice. Adhesive A1 used in first portion L1-1 can be one of a low tack, medium tack or high tack pressure sensitive adhesive depending on the application. First portion L1-1 can range from 10 to 95% of label L total adhesive area. Adhesive A2 is a clean release adhesive and second portion L1-2 using adhesive A2 can range from 0% to 80% of the label L total adhesive area.

As used herein tack is the amount of force require to separate the adhesive portion of a label from its substrate. However, the terms “low,” “medium” and “high” tack are relative terms and are not easily quantified in terms of specific force values. The following examples are used to provide a better understanding how the relative terms “low tack,” “medium tack” and “high tack” are used herein. A label having a low tack pressure sensitive adhesive will be easily removable from its adherent material, i.e., the material to which the label is applied, without tearing and would not damage the adherent material when removed and the low tack adhesive would remain substantially adhered to the label material. A clothing size label applied to the fabric would be one example of a low tack adhesive label. A label having a medium tack adhesive will require greater removal force than a low tack adhesive and when removed may result in tearing of the label as it is intended to be a semi-permanent attachment to the adherent material and portions of the medium tack adhesive may remain on the adherent material after the label is removed. A product name label is one example of a medium tack adhesive label. Removal generally would not damage or cause only minor damage to the adherent material when the label is removed. A label having a high tack adhesive is one where the label is intended to be permanently attached to its adherent material and would be destroyed if removed or the adherent material would be damaged during label removal. An authentication label would be an example of a label having a high tack adhesive.

Examples of a low, medium and high tack adhesives include: Low Tack Adhesive—HL2268; Medium Tack Adhesive—HL2811, and High Tack Adhesive—HM8326, all manufactured by H.B. Fuller Company, 1200 Willow Lake Blvd, St. Paul, Minn. Examples of a clean release adhesive include Clean Release Adhesive HL2999 also manufactured by H.B. Fuller Company. It is expected that these adhesives and other similar adhesives may be used as described with label media printed by electrophotographic printers manufactured by Lexmark International, Inc.

Adhesive A1 is shown as extending across the entire width of label sheet 12. Adhesive A2 is also shown extending across the entire width of label sheet 12 except for a predetermined pattern forming adhesive free zone 18 positioned substantially within a sub-portion of the second portion L1-2 of label L1 and extending inwardly from the edge of the second portion L1-2 of label L1. This helps to ensure that label sheet 12 remains in place on liner sheet 16 during the electrophotographic printing process. The adhesive free zone 18 may range from 5 to 90% of the label L area.

Where adhesive A1 is a low tack adhesive, adhesive A1 releases from liner sheet 16 and adheres to the back side of label L1 when it is removed from label sheet 12. This allows label L1 to be removably adherable to a surface such as an edge of the display shelf. Adhesive A2 is a clean release adhesive used to adhere second portion L1-2 to liner sheet 14 during printing in the electrophotographic printer to prevent that portion of label L1 from moving but releases from the back of second portion L1-2 when label L1 is removed from label sheet 12 so that second portion L1-2 is substantially adhesive free. It other words the clean release adhesive would not be transferred to the label when the label was removed from the liner sheet. Second portion L1-2 would normally depend below the edge of the display shelf and may come into contact with a shopper reaching into a display shelf or with a product being removed from the display shelf where residual tackiness on the label may be problematic.

As shown, the adhesive free zone 18 may also extend outwardly from the edge E of the label into the abutting portions of the label sheet 12. The adhesive free zone 18 is positioned such that the edge E of label L1 within the second portion L1-2 falls within this zone. For a labels having the shape of a parallelogram, adhesive free zone 18 may in one form be generally U-shaped as shown in FIG. 1. In general the adhesive free zone 18 would conform to the shape of the label within second portion L1-2. Advantageously, the adhesive free zone 18 allows label L1 to be easily separated from the label sheet 12 and liner sheet 14. A second adhesive free zone 20 indicated by the dashed lines in first portion L1-1 may also be provided. Where label L1 is being used on the edge of a shelf, the second adhesive free zone 20 may not used so that the edge E within first portion of label L1-2 does not curl.

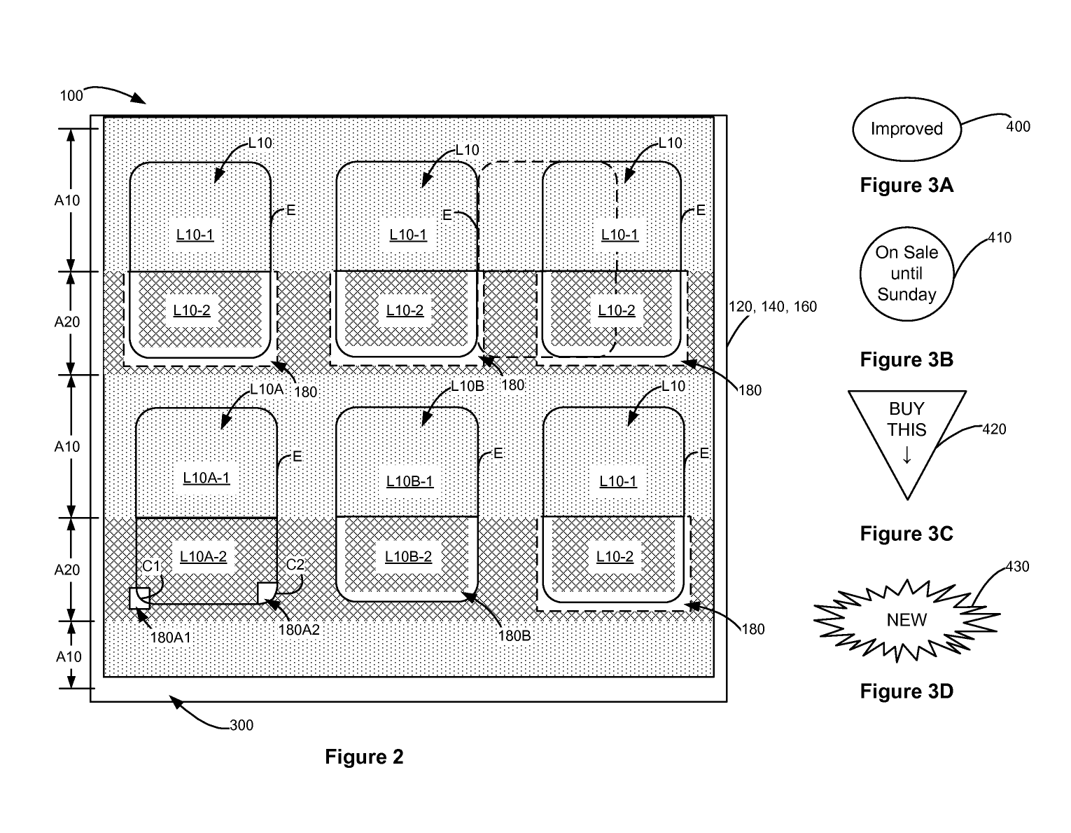

In FIG. 2 another embodiment of a media sheet is illustrated. Where possible, similar elements will carry similar reference numerals to those shown in FIGS. 1A-1B. The label media 100 is provided with an N×M array of labels L10. Label media 100 is constructed in the same manner as label media 10 having a label sheet 120, liner sheet 140 and an adhesive 160 sandwiched between as illustrated for label media 10 in FIG. 1B. A plurality of labels L10 are arranged in an N×M array on label media 100. A 2×3 array of labels L10 is illustrated. The size of the N×M array is a matter of the desired label size and media sheet size. The N×M array may be, for example, a 1×1 array, i.e., a single label, a 4×4 array, a 1×8 array, a 2×12 array, a 3×10 array, a 6×4 array, etc. The labels L10 are shown as separated from one other but they may also abut each other in the row as indicated by the dashed rectangle in the upper right portion of label media 100, allowing for more labels L10 to be provided on a given media.

Alternating bands of adhesives A10 and A20 are applied to the reverse side of label sheet 120 so that each of labels L10 has respective first and second portions L10-1, L10-2 having adhesives A10, A20 thereon, as previously described for label L1. Again the adhesives A10, A20 may be applied to the liner sheet 140. Adhesives A10, A20 correspond to adhesives A1, A2, previously described. Each of labels L10 has an adhesive free zone 180 extending about the edge E of second portions L10-2 which functions as previously described for adhesive free zone 18. In FIG. 2 the bottom band of adhesive A10 is provided to hold the bottom portion of label sheet 120 to liner sheet 140 during printing. In addition an adhesive free border zone 300 is provided about the edges of media sheet 100. Border zone 300 helps to prevent adhesives A10, A20 from oozing off of media sheet 100 during printing or fusing that may gum up the mechanisms within the electrophotographic printer.

Also shown in FIG. 2 is label L10A where the adhesive free zone 180A1 is about at least one corner C1 in second portion L10A-2. First portion L10A-1 is substantially the same as first portions L10-1 previously described. It will be realized that other shapes than the rectangle shown may be used for adhesive free zone 180A1. In corner C2 of label L10A there is shown another example of a corner adhesive free zone 180A2 that does not extend into the abutting regions of label sheet 120. Another form of the U-shaped adhesive free zone is illustrated in label L10B where adhesive free zone 180B is entirely within second portion L10B-2 and does not extend into the abutting regions of label sheet 120.

FIGS. 3A-3D show example shapes of labels that may be formed on label sheet 10, 100. As shown there is an oval label 400, a circular label 410, and a triangular label 420, and a star burst label 430. The size and shape of the label is a matter of design choice and may be in the form of any regular or irregular polygon, ellipse, or combinations thereof. The labels may be printed with informational messaging as illustrated in FIGS. 3A-3D or identifying information.

Label sheets 10, 100 may be formed of various synthetic films such as polyester, vinyl, polyolefin, etc. or a plain paper facestock. The liner sheets 14, 140 may be formed of a silicon impregnated paper. As one of ordinary skill in the art would recognize, the weight of the impregnated paper should be such that it allows the labels to peel free cleanly and run through electrophotographic printers. The label sheets 10, 100 may be used in mono and color electrophotographic printers or imaging devices containing an electrophotographic printer. It should also be realized that the labels just described may be attached to a variety of items including but not limited to shelving, furniture, fabric, shipping bags, laundry bags etc.

The foregoing description of the invention has been presented for purposes of illustration. It is not intended to be exhaustive or to limit the invention to the forms disclosed, and obviously many modifications and variations are possible in light of the above teaching. It is intended that the scope of the invention be defined by the claims appended hereto.

What is claimed is:

1. A media sheet for used in an electrophotographic printer, the media sheet comprising:
a liner sheet;
a label sheet having at least one label precut therein, and
an adhesive for adhering the liner sheet and label sheet together with the at least one label having a first portion having a first adhesive and a second portion of the at least one label having a second adhesive and a predetermined adhesive free zone extending inwardly from an edge of the at least one label within the second portion.

2. The label media of claim 1 wherein the first adhesive is coextensive with all of the edges of the first portion of the label.

3. The label media of claim 1 wherein the first adhesive is a low tack adhesive and the second adhesive is a clean release adhesive.

4. The label media of claim 1 wherein the first adhesive is a medium tack adhesive and the second adhesive is a clean release adhesive.

5. The label media of claim 1 wherein the first adhesive is a high tack adhesive and the second adhesive is a clean release adhesive.

6. The label media of claim 1 wherein the adhesive free zone extends beyond the edge of the second portion of the at least of label into an abutting portion of the label sheet.

7. The label media of claim 1 wherein the adhesive free zone extends along the entire length of the edge of the second portion of the at least one label.

8. The label media of claim 1 wherein the adhesive free zone extends about a corner of the second portion of the at least one label.

9. The label media of claim 1 wherein the at least one label is an N×M array of labels.

10. The label media of claim 1 wherein the label sheet is made of one of polyester, vinyl, and paper.

11. The label media of claim 1 wherein the liner sheet is made of a silicone impregnated paper.

12. A media sheet for used in an electrophotographic printer, the media sheet comprising:
a liner sheet;
a label sheet having an N×M array of labels precut therein, and
an adhesive for adhering the liner sheet and label sheet together with each label in the N×M array having a first portion having a first adhesive and a second portion having a second adhesive and a predetermined adhesive free zone extending inwardly from an edge of the second portion; and
the label sheet having an adhesive free border zone extending inwardly from an edge of the label sheet.

13. The label media of claim 12 wherein for each label the first adhesive is coextensive with all of the edges of the first portion of the label.

14. The label media of claim 12 wherein the first adhesive is a low tack adhesive and the second adhesive is a clean release adhesive.

15. The label media of claim 12 wherein the first adhesive is a medium tack adhesive and the second adhesive is a clean release adhesive.

16. The label media of claim 12 wherein the first adhesive is a high tack adhesive and the second adhesive is a clean release adhesive.

17. The label media of claim 12 wherein for each label the adhesive free zone extends beyond the edge of the second portion of each label into an abutting portion of the label sheet.

18. The label media of claim 12 wherein for each label the adhesive free zone extends along the entire length of the edge of the second portion of each label.

19. The label media of claim 12 wherein the adhesive free zone for each label extends about a corner of the second portion of the at least one label.

20. The label media of claim 12 wherein the label sheet is made of polyester, vinyl and paper.

21. The label media of claim 12 wherein the liner sheet is made of a silicone impregnated paper.
